(19) United States
(12) Patent Application Publication
(10) Pub. No.: US 2007/0078907 A1
(43) Pub. Date: Apr. 5, 2007

(54) Method for updating function of handheld apparatus through plug-and play (PnP) storage device

(76) Inventor: Ming-Tsung Chiang, Taipei County (TW)

Correspondence Address: HARNESS, DICKEY & PIERCE, P.L.C., P.O. BOX 8910, RESTON, VA, 20195, US

(21) Appl. No.: 11/242,868

(22) Filed: Oct. 5, 2005

(51) Int. Cl. G06F 17/30

(52) U.S. Cl. 707/203

(57) ABSTRACT

A method for updating the function of a handheld apparatus through a plug-and-play (PnP) storage device. The handheld apparatus has an operating system, a current version application and a plurality of objects, and provides an expansion interface so as to be compatible with the PnP storage device. When the operating system detects an updated version application stored in the PnP storage device, a conflicting selection to perform the current version application or the updated version application is provided, the operating system performing to overwrite the current version application with the updated version application; and when performing either version application, the user optionally place an expansion object of the PnP storage device into the handheld device.

### BACKGROUND OF THE INVENTION

1. Field of Invention

The present invention relates to a method for updating the function of a handheld apparatus, particularly to a method for updating the function of a handheld apparatus through a plug-and-play (PnP) storage device.

2. Related Art

In the embedded system of the handheld apparatus including mobile phone, PDA, digital camera and the like, the software or firmware of the system is usually maintained in a memory chip. Since the flash memory can be erased and programmed, it brings great convenience to the system software upgrade, and thus is widely applied to save codes and data in the handheld apparatus. However, the compiled and linked object codes must be downloaded into the flash memory of the handheld apparatus by the download tool.

The requirements for the functions of the download tool are varied from development to production, to maintenance and finally to the terminal user. Therefore, as to the design of the software architecture for the general download tool, in addition to the understanding of the functional requirements for the download tool in various applications, the convenient download and update mode is quite an issue.

FIG. 1 is a schematic view of updating the function of the handheld apparatus of the prior art. Simply in respect of the user, the object download of the handheld apparatus 10 is mostly carried out through the Internet 20 or the wireless telecommunication network 30. However, at present, the function update of the handheld apparatus 10 in most cases provides downloads to the computer 50 through the WEB server 40, or access to the computer 50 through the storage apparatus 60, and then the update for the software or firmware of the system is conducted through the connection between the terminal of the computer 50 and the handheld apparatus 40. The user's requirements for expanding the function of the handheld apparatus 10 are increasing, however, any more convenient way of updating the software and firmware of the system has not been met yet.

The existing PnP storage device (for example, a SD card, etc.) is similar to a diskette in use as a storage medium, and the content in the SD card have to be browsed so as to retrieve or perform the desired program or data, when it is used. Whereas the PnP storage device similar to SD card has been increasingly used in the consumer products such as the handheld apparatus (including digital cameras, mobile phones and the like), the use of such products are no longer like computer that requires the user to have certain ability. Therefore, it becomes an interesting issue as to how to make the PnP storage device more close to life and thus make it useful equipment for the consumer products.

### SUMMARY OF THE INVENTION

In view of the above problems, the primary object of the present invention is to provide a method for updating the function of a handheld apparatus through a PnP storage device, wherein the handheld apparatus has an operating system, a current version application and a plurality of objects, and provides an expansion interface to be compatible with the PnP storage device. When the operating system detects an updated version application stored in the PnP storage device, a conflicting selection to perform the current version application or the updated version application is provided, the operating system performing to overwrite the current version application with the updated version application; and while performing either version application, the user optionally place an expansion object of the PnP storage device into the handheld device. Furthermore, the present invention can also be used to update the version object. When the operating system detects an updated version object of the PnP storage device, a conflicting selection to perform the current version object or the updated version object is provided; and when the user chooses the updated version object, the operating system performs to overwrite the current version object with the updated version object into the handheld device.

In order to facilitate the user to update, i.e. to update or expand the function and object of the handheld apparatus with the PnP storage device anytime and anywhere, the storage device is provided with the functions of hot plug-in and pullout and plug-and-play, and can be connected with the compatible handheld apparatus to access the data, including data for the operating interface update of the handheld apparatus, data for the images and photos of the digital camera, data for PDA, music data of MP3 Walkman, data for mobile phone and the like, and is suitable for the storage specifications of various memory cards.

The PnP storage device mentioned in the present invention supports various kinds of memory cards commercially available, for example CF, MicroDrive (Type I, Type II), SM, MMC, SD, MS, MS Pro, etc. which however are not intended to limit the application scope of the present invention.

The particular features and advantages of the present invention will be described in the embodiments in detail, whose contents are sufficient for any person skilled in the art to understand the technology of the present invention and carry it out accordingly, and any advantage and object related to the present invention can be understood easily from the contents, claims and drawings disclosed in the specification.

The above and following illustration referring to the contents and the embodiment of the present invention are used to exemplify and explain the principle of the present invention, and further provide explanation to the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of updating the function of the handheld apparatus of the prior art; and

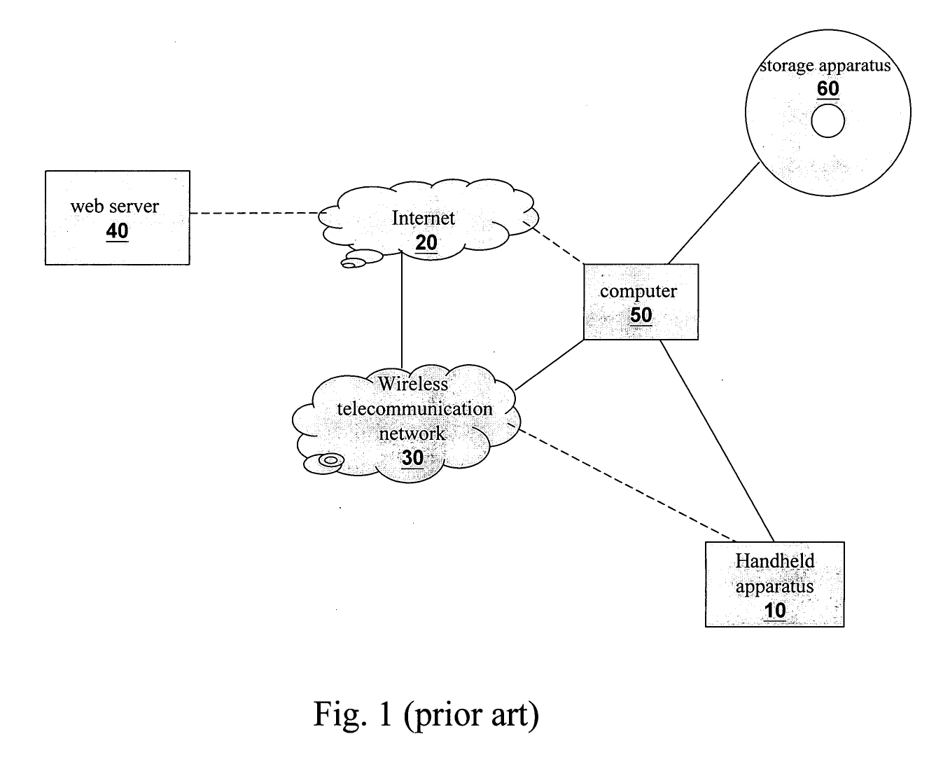

FIG. 2 is a flow chart of the method of the present invention.

### DETAILED DESCRIPTION OF THE INVENTION

The features and examples of the present invention will be illustrated in detail in the preferred embodiments in conjunction with the drawings as below.

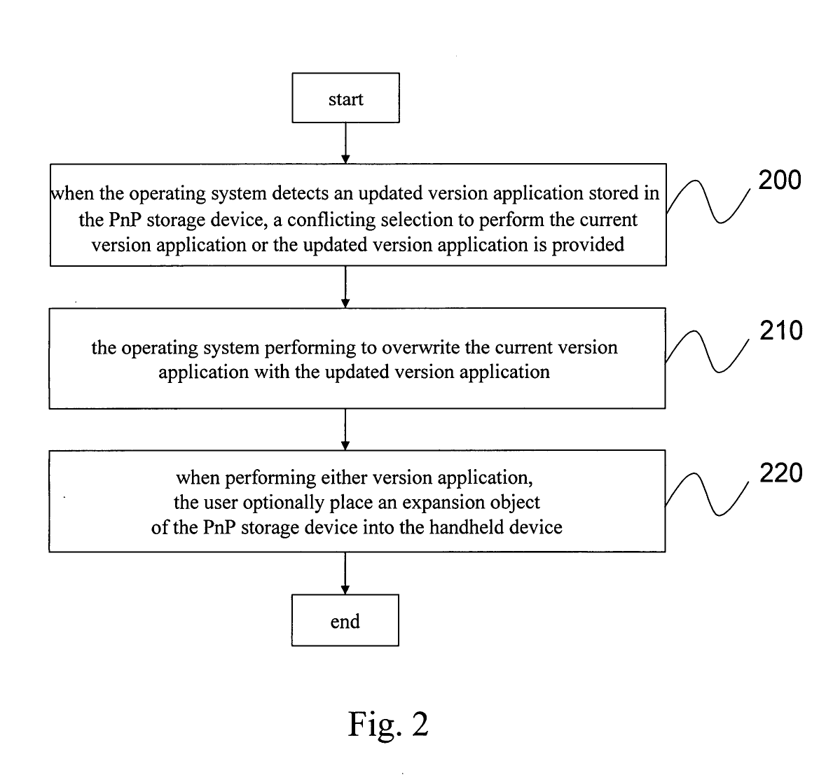

The present invention discloses a method for updating the function of a handheld apparatus through a PnP storage device. Referring to FIG. 2, first, the handheld apparatus has an operating system, a current version application and a plurality of objects including data file, icon file, sound file or video file; and it also provides an expansion interface so as to be compatible with the PnP storage device. When the operating system detects an updated version application stored in the PnP storage device, a conflicting selection to perform the current version application or the updated version application is provided (Step 200); the operating system performing to overwrite the current version application with the updated version application (Step 210); and when performing either version application, the user optionally place an expansion object of the PnP storage device into the handheld device (Step 220). Moreover, the method of the present invention is also independently suitable for the application of updating the objects, i.e. the objects may be updated without updating the application. When the operating system detects an updated version object of the PnP storage device, a conflicting selection to perform the current version object or the updated version object is provided; and when the user chooses the updated version object, the operating system performs to overwrite the current version object with the updated version object into the handheld device. It is further possible to automatically or manually perform the updated version object by setting the handheld apparatus system.

With the method of the present invention, the user need not browse the PnP storage device during using. When the PnP storage device is plugged into the handheld apparatus, the using frame of the PnP storage device will be automatically activated; the content (updated version object), updated version application contained in the PnP storage device will be verified with the system. When the updated version application is compatible with the operating system or when the content is compatible with the application of the handheld apparatus, the system will produce a selection prompt (as shown in the frame), and then update the contents or the updated version application stored in the PnP storage device to the system of the handheld apparatus based upon the requirement of the user. It is also, of course, possible to set whether to activate the automatic execution mechanism or not by the system. When using the contents of the PnP storage device, the system will update the contents to the designated location of the directory without the need to specify the location of placement, since the directory structure has been compiled preliminarily.

The present invention proposes a preferred embodiment to illustrate the feasibility of the method disclosed by the present invention, but not intended to limit the application scope of the present invention. When the handheld apparatus detects that a PnP storage device has been plugged in, and finds the automatic execution program and the related help files on the PnP storage device, it starts to verify the files. If the files comply with the system specification, the automatic execution mechanism will be activated. Since the device employing the PnP storage device is not an integral system, such preferred embodiment includes the following three parts: (1) the design for the content of the PnP storage device, (2) requirement for the operating system, and (3) the handheld apparatus including the particular application interface, so as to support the compatibility with the PnP storage device.

The examples concerning these three parts are illustrated respectively as follows:

(1) Design for the content of the PnP storage device including:

1. Executive file (root directory):

Two forms:

a. Portable executive file, for example, Java

b. Script file, for example, Macromedia Flash

2. Help file (root directory): describing the content of the PnP storage device, the executive file version and the system requirements, the application interface requirements and its version.

3. Data file: data required by the executive file

(2) Requirements by the operating system of the PnP storage device:

Different environments for different contents of the PnP storage device, for example:

1. When performing Java PnP storage device, the system must have Java VM.

2. When performing Flash PnP storage device, the system must have Macromedia Flash.

(3) Basic operating application interface (provided by the operation system) for the handheld apparatus, with several functions listed below:

1. Providing an automatic execution file to query whether there is any expanded application interface available.

2. Only providing access to the files in the PnP storage device.

3. Providing update for the contents of the system, for example wallpaper, picture, sound, video, icon and the like.

4. Providing update selection for the firmware of the system.

5. Providing the interface for the system resources, including:
input device: input keys, touch screen, files
output device: display, sound, files
communication networks: communication channel
event notification: peripheral plug-in and pullout notification
other resources: system time, other input/output device

6. Operating interface updating:

The PnP storage device mentioned in the present invention supports various kinds of memory cards commercially available, for example CF, MicroDrive (Type I, Type II), SM, MMC, SD, MS, MS Pro, which, however, are not intended to limit the application scope of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for updating the function of a handheld apparatus through a plug-and-play (PnP) storage device, wherein the handheld apparatus has an operating system, a current version application and a plurality of objects, and it also provides an expansion interface so as to be compatible with the PnP storage device, said method comprising:
when the operating system detects an updated version application stored in the plug-and-play (PnP) storage device, a conflicting selection to perform the current version application or the updated version application is provided;
the operating system performing to overwrite the current version application with the updated version application; and
when performing either version application, the user optionally place an expansion object of the PnP storage device into the handheld device.

2. The method for updating the function of a handheld apparatus through a plug-and-play (PnP) storage device according to claim 1, wherein the updated version application is a portable executive file.

3. The method for updating the function of a handheld apparatus through a plug-and-play (PnP) storage device according to claim 2, wherein the portable executive file is a Java file.

4. The method for updating the function of a handheld apparatus through a plug-and-play (PnP) storage device according to claim 2, wherein the step of the operating system performing to overwrite the current version application with the updated version application is automatically performed or manually performed by the user choosing the updated version application.

5. The method for updating the function of a handheld apparatus through a plug-and-play (PnP) storage device according to claim 2, wherein the updated version application is compatible with the operating system.

6. The method for updating the function of a handheld apparatus through a plug-and-play (PnP) storage device according to claim 1, wherein the object comprises data file, icon file, sound file or video file.

7. The method for updating the function of a handheld apparatus through a plug-and-play (PnP) storage device according to claim 2, wherein the updated version application further comprises a step of updating the firmware of the handheld apparatus.

8. The method for updating the function of a handheld apparatus through a plug-and-play (PnP) storage device according to claim 2, wherein the updated version application further comprises a data file required when executing.

9. The method for updating the function of a handheld apparatus through a plug-and-play (PnP) storage device according to claim 1, wherein the updated version application is a Script file.

10. The method for updating the function of a handheld apparatus through a plug-and-play (PnP) storage device according to claim 9, wherein the portable executive file is a Macromedia Flash file.

11. The method for updating the function of a handheld apparatus through a plug-and-play (PnP) storage device according to claim 9, wherein the step of the operating system performing to overwrite the current version application with the updated version application is automatically performed or manually performed by the user choosing the updated version application.

12. The method for updating the function of a handheld apparatus through a plug-and-play (PnP) storage device according to claim 9, wherein the updated version application is compatible with the operating system.

13. The method for updating the function of a handheld apparatus through a plug-and-play (PnP) storage device according to claim 9, wherein the updated version application further comprises a step of updating the firmware of the handheld apparatus.

14. The method for updating the function of a handheld apparatus through a plug-and-play (PnP) storage device according to claim 9, wherein the updated version application further comprises a data file required when executing.

15. A method for updating the function of a handheld apparatus through a plug-and-play (PnP) storage device, wherein the handheld apparatus has an operating system, a current version application and a plurality of current version objects, and provides an expansion interface so as to be compatible with the PnP storage device, said method comprising:
when the operating system detects an updated version object stored in the PnP storage device, a conflicting selection to perform the current version object or the updated version object is provided;
the operating system performing to overwrite the current version object with the updated version object into the handheld device.

16. The method for updating the function of a handheld apparatus through a plug-and-play (PnP) storage device according to claim 15, further comprising a step of automatically performing the updated version application.

17. The method for updating the function of a handheld apparatus through a plug-and-play (PnP) storage device according to claim 15, wherein the updated version application is compatible with the operating system.

18. The method for updating the function of a handheld apparatus through a plug-and-play (PnP) storage device according to claim 15, wherein the object comprises data file, icon file, sound file or video file.
